(19) United States
(12) Patent Application Publication
(10) Pub. No.: US 2016/0242186 A1
(43) Pub. Date: Aug. 18, 2016

(54) Dynamic Carrier Selection Via Auxiliary Carriers In Unlicensed Band

(71) Applicant: Nokia Technologies Oy, Espoo (FI)

(72) Inventor: Mauri J. Nissila, Oulu (FI)

(73) Assignee: Nokia Technologies Oy

(21) Appl. No.: 14/620,426

(22) Filed: Feb. 12, 2015

(51) Int. Cl. H04W 72/04; H04W 28/02; H04L 1/18; H04L 5/00

(52) U.S. Cl. CPC H04W 72/0486; H04L 5/001; H04W 28/0252; H04L 1/1812; H04L 5/0032; H04L 1/1893

(57) ABSTRACT

In accordance with the exemplary embodiments there is at least a method and apparatus to configure more than one component carrier of an unlicensed band, wherein some of the more than one component carriers are active and a remainder are turned off; select at least one turned off component carrier of the more than one component carrier, wherein each of the selected at least one turned off component carrier is configured as an auxiliary component carrier linked to one or more of the active component carriers of the unlicensed band; and send a data burst over an auxiliary component carrier in response to a linked active component carrier being unavailable to carry the data burst. Further, in accordance with the exemplary embodiments there is at least a method and apparatus to receive a configuration of an auxiliary component carrier via one of broadcast signaling or radio resource control signaling; detect a data burst over the auxiliary component carrier of more than one component carrier associated with an unlicensed band.

### TECHNICAL FIELD

The teachings in accordance with the exemplary embodiments of this invention relate generally to dynamic carrier selection in an unlicensed band and, more specifically, relate to operations which enable a communication device to control and implement component carriers for dynamic carrier selection or re-selection in an unlicensed band.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
ACC auxiliary component carrier
AP access point
CA carrier aggregation
CC component carrier
CCA clear channel assessment
CQI channel quality indicator
CRS cell-specific reference signal
CSI channel state information
eNB base station
FBE frame based equipment
GW gateway
HARQ hybrid automatic repeat request
LAA licensed-assisted access
LBE load based equipment
LBT listen before talk
LTE long term evolution
PDCCH physical downlink control channel
PDCP packet data convergence protocol
PDSCH physical downlink shared channel
PSS primary synchronization signal
QoS quality of service
RAN radio access network
RAT radio access technology
RLC radio link control
RRC radio resource control
RRM radio resource manager
SCC secondary component carrier
SI system information
SSS secondary synchronization signal
UE user equipment
WiFi wireless fidelity
WLAN wireless local area network

LTE Advanced offers higher data rates than prior releases. However, even though spectrum usage efficiency has improved, sometimes this alone cannot enable access data rates that may be required by some devices.

One method to achieve even higher data rates is to increase transmission bandwidths over those supported by a single carrier or channel is to use carrier aggregation (CA), or aggregation. Using carrier aggregation it is possible to utilize more than one carrier and in this way increase the overall transmission bandwidth.

A major goal of carrier aggregation is to provide enhanced and consistent user experience across the cell such as by maximizing a peak data rate and throughput, improving mobility and mitigating relative inefficiencies, and providing load-balancing and thus more consistent QoS of data transmission thanks to the load-balancing.

The exemplary embodiments of the invention as discussed herein work to improve carrier selection for communications in an unlicensed band.

### SUMMARY

In an exemplary aspect of the invention, there is an apparatus comprising: at least one processor; and at least one memory including computer program code, where the at least one memory and the computer program code are configured, with the at least one processor, to cause the apparatus to at least: configure more than one component carrier of an unlicensed band, wherein some of the more than one component carriers are active and a remainder are turned off; select at least one turned off component carrier of the more than one component carrier, wherein each of the selected at least one turned off component carrier is configured as an auxiliary component carrier linked to one or more of the active component carriers of the unlicensed band; and send a data burst over an auxiliary component carrier in response to a linked active component carrier being unavailable to carry the data burst.

In an exemplary aspect of the invention, there is a method comprising: configuring more than one component carrier of an unlicensed band, wherein some of the more than one component carriers are active and a remainder are turned off; selecting at least one turned off component carrier of the more than one component carrier, wherein each of the selected at least one turned off component carrier is configured as an auxiliary component carrier linked to one or more of the active component carriers of the unlicensed band; and sending a data burst over an auxiliary component carrier in response to a linked active component carrier being unavailable to carry the data burst.

In another exemplary aspect of the invention, there is apparatus comprising: at least one processor; and at least one memory including computer program code, where the at least one memory and the computer program code are configured, with the at least one processor, to cause the apparatus to at least: receive a configuration of an auxiliary component carrier via one of broadcast signaling or radio resource control signaling; detect a data burst over the configured auxiliary component carrier of more than one component carrier associated with an unlicensed band.

In still another exemplary aspect of the invention, there is method comprising: receiving, by a user equipment, a configuration of an auxiliary component carrier via one of broadcast signaling or radio resource control signaling; and detecting a data burst over the auxiliary component carrier of more than one component carrier associated with an unlicensed band.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is a diagram illustrating an example of a User Equipment (UE) in partially overlapping cells;

FIG. 2 shows a simplified block diagram of devices configured to perform operations in accordance with the exemplary embodiments of the invention;

FIG. 3 shows a timing diagram for frame based equipment in accordance with the exemplary embodiments of the invention;

FIG. 4 shows a description of data flow of SCells of an unlicensed band in accordance with an exemplary embodiment of the invention;

FIG. 5 shows a sample configuration including an auxiliary component carrier in accordance with an exemplary embodiment of the invention;

FIG. 6 shows a schematic diagram in plain view (left) and sectional view (right) of a mobile handset capable of performing operations according to an exemplary embodiment of the invention; and

FIGS. 7A and 7B each show a method in accordance with the exemplary embodiments which may be performed by an apparatus.

### DETAILED DESCRIPTION

In this invention, there is provided at least a method and apparatus to control and implement component carriers for dynamic carrier selection or re-selection in an unlicensed band.

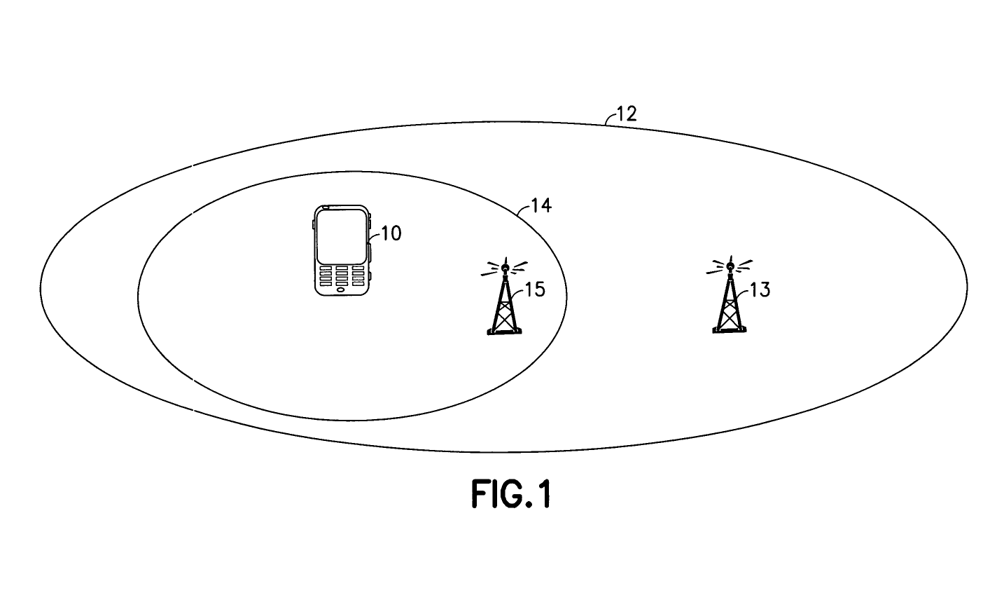

FIG. 1 shows an example of overall architecture of an E-UTRAN system. The E-UTRAN system includes eNBs, providing an E-UTRAN user plane (PDCP/RLC/MAC/PHY) and control plane (RRC) protocol terminations towards the UE (not shown in FIG. 1). The eNBs are interconnected with each other by means of an X2 interface. The eNBs are also connected by means of a S1 interface to an EPC (Enhanced Packet Core), more specifically to a MME (Mobility Management Entity) by means of a S1 MME interface and to a Serving Gateway (S-GW) by means of a S1 interface. The S1 interface supports a many-to-many relationship between MMEs/S-GW and eNBs.

Referring also to FIG. 1, a UE 10 may be connected to more than one cell at a same time. In this example the UE 10 is connected to a PCell 12 through a base station 13 (such as an eNB for example) and a SCell 14 through a base station 15 (such as an eNB or WiFi Access Point for example). The two cells 12, 14 are, thus, at least partially overlapping. The PCell 12 may operate on a licensed band or unlicensed band and similarly the SCell 14 may operate on a licensed or unlicensed band, such as ISM bands. In certain scenarios, the SCell may operate also on licensed band(s). The PCell may be either a FDD cell or TDD cell for example. For simplicity, there are just one PCell and one SCell depicted in the scenario shown in FIG. 1. In other alternate examples any number of cells (PCell and SCell) operating on licensed and/or unlicensed band(s) may be provided to work together for a suitable Carrier Aggregation (CA). For example when UE uses licensed LTE, unlicensed LTE and Wi-Fi connections may be activated to perform aggregation over the three radio technologies to reach highest bit rates when seen feasible and UE and network support this. A Wi-Fi link in accordance with the exemplary embodiments can be utilized in an unlicensed band, unless also licensed variant is specified. In one type of example embodiment the PCell and SCell may be co-located.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, including portable units or terminals that incorporate combinations of such functions.

Features as described herein may be used in relation to an LTE-Advanced system. More specifically, features as described herein may be used on LTE operation in an unlicensed spectrum also known as Licensed-Assisted Access (LAA). The LTE LAA operation may be based on LTE Carrier Aggregation (CA). Thus, a CA primary cell (PCell) may remain on a licensed band while a secondary cell (SCell) may be on an unlicensed spectrum, or vice versa. Licensed-Assisted Carrier Aggregation operation may be used to aggregate a primary cell, which uses a licensed spectrum, with an at least partially overlapping secondary cell, which uses an unlicensed spectrum. In one type of example embodiment the carrier aggregation principle may assume LTE Re1-10/11/12/13 Carrier Aggregation scenario with co-located cells and/or non-collocated cells connected with (close to) ideal backhaul. Alternatively, in another type of example embodiment the carrier aggregation principle may assume Rel-12 Small Cell or Dual Connectivity scenario with non-collocated cells (unlicensed and licensed) and (close to) ideal or non-ideal backhaul between them. Use of the unlicensed spectrum may deliver information to opportunistically boost data rate. The secondary cell may be used for supplemental downlink capacity only, or both downlink and uplink capacity.

In conventional LTE LAA, before being permitted to transmit, a user or an access point (such as eNodeB) may, depending on the regulatory requirements, need to monitor the given radio frequency for a short period of time to ensure the spectrum is not already occupied by some other transmission (referred to as List-Before-talk (LBT)). The requirements for LBT vary depending on the geographic region. For example in the US such requirements do not exist, whereas in Europe the network elements operating on unlicensed bands need to comply with LBT requirements. In one example, the LTE LAA may apply a listen before talk (LBT) procedure, such as based on European regulatory rules defined for 5 GHz ISM band. It may also fulfill other regulatory rules applying a LBT procedure, such as regional regulatory rules for example. The exemplary embodiments of the invention provide at least an improved method to ensure a spectrum is not already occupied by some other transmission.

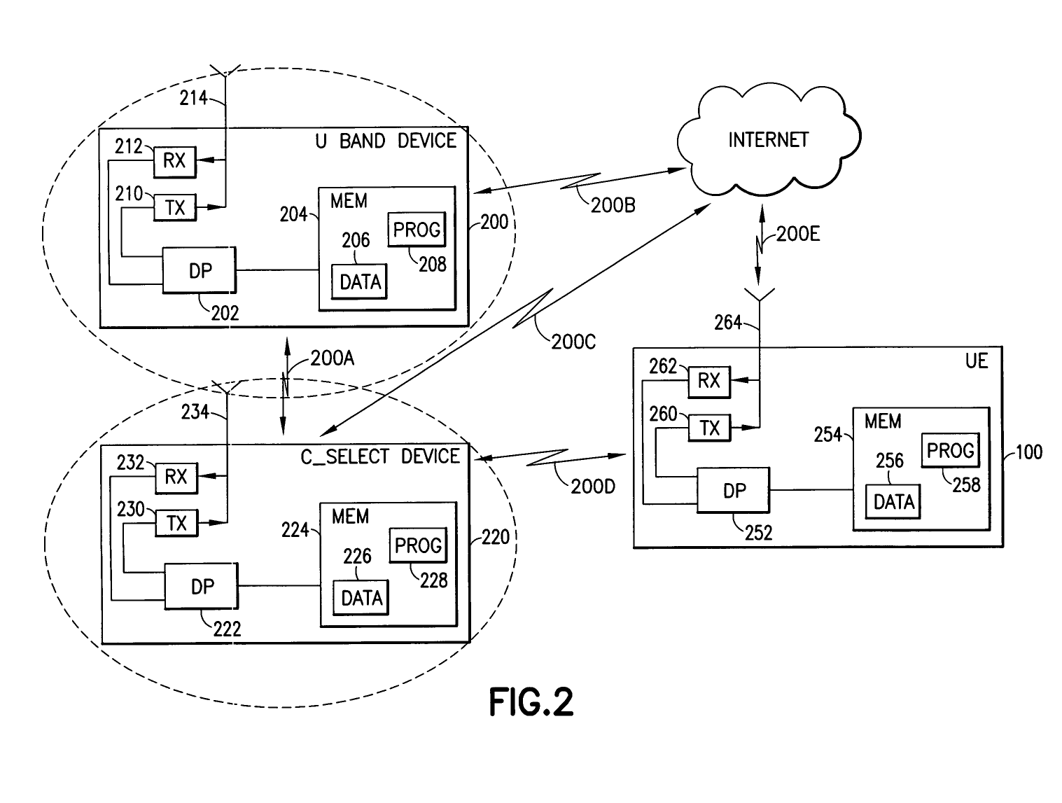

Before describing the exemplary embodiments of the invention in further detail reference is now made to FIG. 2. FIG. 2 illustrates a simplified block diagram of devices such as an unlicensed band device or U band device 200 and a carrier select device or a C_select device 220, and a user device such as a UE 100, suitable for use in practicing the exemplary embodiments of this invention. In FIG. 2 apparatuses, such as the U band device 200 and the C_select device 220, are adapted for communication with other apparatuses having wireless communication capability, such as each other and the UE 100.

The C_select device 220 includes processing means such as at least one data processor (DP) 222, storing means such as at least one computer-readable memory (MEM) 224 storing data 226 and at least one computer program (PROG) 228 or other set of executable instructions, communicating means such as a transmitter TX 230 and a receiver RX 232 for bidirectional wireless communications with the UE 100 via an antenna 234. Further, the C_select device 220 can be any device capable of performing the operations in accordance with the exemplary embodiments. For example, such a C_select device may be a server, a base station, and any type of network device.

The U band device 200 includes processing means such as at least one data processor (DP) 202, storing means such as at least one computer-readable memory (MEM) 204 storing data 206 and at least one computer program (PROG) 208 or other set of executable instructions, communicating means such as a transmitter TX 210 and a receiver RX 212 for bidirectional wireless communications with the UE 100 via an antenna 214.

It is noted that in FIG. 2 there are dashed lines around the C_select device 220 and the U band device 200. These dashed lines may indicate cells, such as a PCell 12 and/or and SCell 14 as shown in FIG. 1. Further, the cells may be different cells or the same cell, such as the may be both part of a same cell A for example, or they may be different cells such as a cell A and a cell B for example. In addition, C_select device 220 and/or U band device 200 may be incorporated into a network device such as an eNB. The C_select device 220 and/or U band device 200 can be separate from the cell(s) and located elsewhere such as in a wireless network or another network. Further, the C_select device 220 and/or U band device 200 may include a server such as a carrier aggregation capable server.

The UE 100 includes processing means such as at least one data processor (DP) 252, storing means such as at least one computer-readable memory (MEM) 254 storing data 256 and at least one computer program (PROG) 258 or other set of executable instructions, communicating means such as a transmitter TX 260 and a receiver RX 262 for bidirectional wireless communications with the U band device 200 or the C_select device 220 via one or more antennas 264. UE capable of dual connectivity may have multiple transmitters TX and receivers RX to enable simultaneous communication with U band device 200 and C_select device 220. In addition, it is noted that although FIG. 2 may only illustrate one transmitter TX and one receiver RX in the U band device 200, the C_select device 220, and the UE 100 this is non-limiting in accordance with the exemplary embodiments and these devices can each be configured to simultaneously support multiple RX and/or TX communications or chains with multiple devices. In accordance with the exemplary embodiments the data 206, 226, and/or 256 may include data required to implement a method and operate an apparatus in accordance with the exemplary embodiments of the invention.

At least one of the PROGs 228 in the C_select device 220 is assumed to include a set of program instructions that, when executed by the associated DP 222, enable the device to operate in accordance with the exemplary embodiments of this invention, as detailed above. In these regards the exemplary embodiments of this invention may be implemented at least in part by computer software stored on the MEM 224, which is executable by the DP 222 of the C_select device 220, or by hardware, or by a combination of tangibly stored software and hardware (and tangibly stored firmware).

Similarly, at least one of the PROGs 208 in the U band device 200 is assumed to include a set of program instructions that, when executed by the associated DP 202, enable the device to operate in accordance with the exemplary embodiments of this invention, as detailed above. In these regards the exemplary embodiments of this invention may be implemented at least in part by computer software stored on the MEM 204, which is executable by the DP 202 of the U band device 200, or by hardware, or by a combination of tangibly stored software and hardware (and tangibly stored firmware). Further, it is noted that the U band device 200 can be any device associated with an unlicensed band such as, but not limited to, an access point, a base station, and a server.

Similarly, at least one of the PROGs 258 in the UE 100 is assumed to include a set of program instructions that, when executed by the associated DP 252, enable the device to operate in accordance with the exemplary embodiments of this invention, as detailed herein. In these regards the exemplary embodiments of this invention may be implemented at least in part by computer software stored on the MEM 254, which is executable by the DP 252 of the UE 100, or by hardware, or by a combination of tangibly stored software and hardware (and tangibly stored firmware). Electronic devices implementing these aspects of the invention need not be the entire devices as depicted at FIG. 2 or may be one or more components of same such as the above described tangibly stored software, hardware, firmware and DP, or a system on a chip SOC or an application specific integrated circuit ASIC.

As shown in FIG. 2 communication between the U band device 200 and the C_select device 220 can be made via one or more links 200A. Further, communication between the U band device 200 and the C_select device 220 can be using another network such as the Internet as shown with links 200B and 200C. In addition, the UE 100 may communicate with the C_select device 220 and/or the U band device 200 using at least one of communication paths link 200D, 200E, 200C, 200B, and/or 200A. Further, any of these links can be wired and/or wireless links, and any of these links can be backhaul type links. Further, the communication path link 200E can represent at least in part a Wi-Fi link. The link 200E and/or 200C may include a wireless access point which may facilitate such a Wi-Fi link in accordance with the exemplary embodiments of the invention. The Wi-Fi link may be based on IEEE 802.11 standards. Such standards including media access control (MAC) and physical layer (PHY) specifications for implementing wireless local area network (WLAN) computer communication in at least 2.4, 3.6, 5, and 60 GHz frequency bands.

In general, the various embodiments of the UE 100 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 204, 224, and 254 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 202, 222, and 252 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

The exemplary embodiments of the invention can be utilized in at least LTE-Advanced system Rel-13. In particular, the embodiments of the invention focus on LTE operation on unlicensed band aka LTE-LAA system which is currently under study in 3GPP (SID in RP-141664). It is widely assumed that LTE LAA operation is based on LTE Carrier Aggregation (CA) so that CA primary cell (PCell) remains on a licensed band while secondary cell (SCell) may locate on unlicensed spectrum.

It is noted that 3GPP rel-13 and beyond can include LTE/Wi-Fi aggregation technology where an eNB manages UE mobility but can utilize Wi-Fi as a second carrier for data transmission (Wi-Fi as data pump), for example to increase peak bit rate. The new use cases enabled include e.g., carrier aggregation, and complete network control of available resources and dynamic radio resource usage based on load and radio quality. LTE PDCP or even RLC is expected to be used on top of Wi-Fi stack multiplexing PDCP/RLC blocks over LTE and Wi-Fi radios and de-multiplexing received packets to form once again complete IP packets despite if both LTE and Wi-Fi are used. Another main alternative is to use Serving GW to distribute selected traffic over LTE access and other traffic over Wi-Fi access. This invention applies to all these scenarios.

In the following, we assume that LTE LAA applies a listen before talk (LBT) procedure based on European regulatory rules defined for 5 GHz ISM band, and that LTE LBT procedure fulfils the European regulatory rules defined either for frame based equipment or for load based equipment, discussed further in the following paragraphs. The scope of the invention is to reduce average latency of data transmission caused by LBT operation (or some other co-existence mechanism) in the LTE LAA context.

Regulatory Framework

Different regions have different regulatory requirements for unlicensed band operation. These are summarized in 3GPP Tdoc RP-140054 (“Review of Regulatory Requirements for Unlicensed Spectrum”). Despite of the regulatory rules, LTE has not yet been deployed in unlicensed spectrum.

In Europe, the regulations mandate the equipment operating on unlicensed spectrum to implement LBT by performing Clear Channel Assessment (CCA) before starting a transmission, to verify that the operating channel is not occupied. ETSI document EN 301 893 defines European regulatory requirements for unlicensed 5 GHz band. It defines two of modes of operation: Frame Based Equipment (FBE), and Load Based Equipment (LBE). The key properties and the differences between these options can be summarized as follows:

Frame Based Equipment:

Frame based equipment is the equipment where the transmit/receive structure is not directly demand-driven but has fixed timing. The corresponding European regulatory rules are defined in ETSI document EN 301 893 and can be summarized as follows:

LBT/CCA is performed periodically at predefined time instances according to a predetermined frame structure;
The periodicity (Fixed Frame Period)=channel occupancy time+idle period);

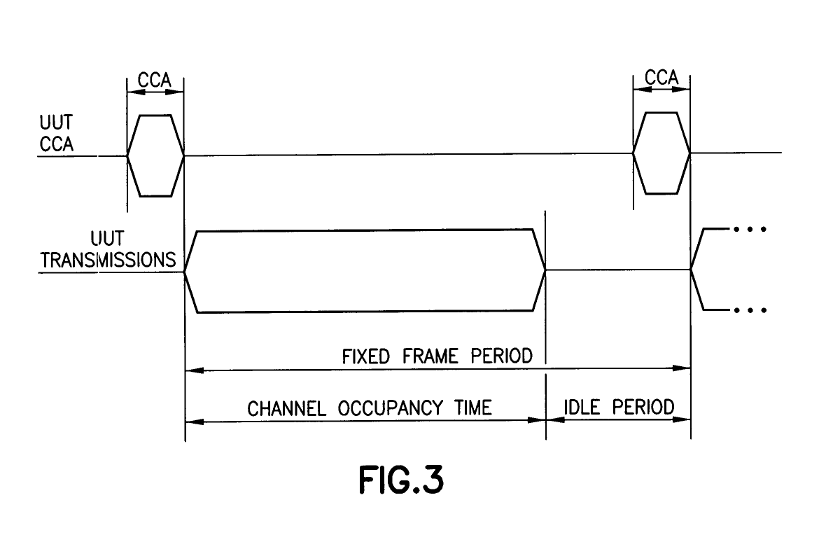

If the equipment finds the Operating Channel(s) to be clear, it may transmit immediately;
The total time during which an equipment has transmissions on a given channel without re-evaluating the availability of that channel, is defined as the Channel Occupancy Time (see the FIG. 3);

If the equipment finds an Operating Channel occupied, it shall not transmit on that channel during the next Fixed Frame Period;

Equipment where the transmit/receive structure is not fixed in time but demand-driven.

FBE relies on a frame structure as given by frame based equipment operation and might suit better the LTE frame and the related carrier aggregation operation intended for LTE LAA. It is noted that operating FBE with a long fixed frame structure (e.g. 10 ms) might result in a low chance to find the channel unoccupied (low channel utilization) when co-existing with some LBE on the same carrier.

The fixed frame period consists of channel occupancy time (such as 1-10 ms for example) and idle period. The Idle period needs to be at least 5% of the channel occupancy time according to ETSI regulations. The device performs LBT periodically (the CCA has observation period) which lasts at least 20 μs (or at least 18 μs based on another specification version). If the equipment finds the Operating Channel(s) to be clear, it may transmit immediately. The total time during which equipment has transmissions on a given channel without re-evaluating the availability of that channel is defined as the Channel Occupancy Time. If the equipment finds an Operating Channel occupied, it shall not transmit on that channel during the next Fixed Frame Period.

Load Based Equipment:

Unlike for FBE, Load based equipment is not restricted to perform LBT/CCA according to a frame structure. Instead, LBE may perform LBT (CCA) whenever it has data to transmit. The key points can be summarized as follows:

Before a transmission or a burst of transmissions on an Operating Channel, the equipment shall perform a Clear Channel Assessment (CCA) check using “energy detect”;

If the equipment finds the Operating Channel(s) to be clear, it may transmit immediately;
The total time that an equipment makes use of an Operating

Channel is the Maximum Channel Occupancy Time which shall be less than (13/32)×q ms, where q={4 . . . 32}. I.e. when q=32, the Maximum Channel Occupancy Time=13 ms;

If the equipment finds an Operating Channel occupied, it shall not transmit in that channel;
The equipment shall then perform an Extended CCA check in which the Operating Channel(s) is/are observed for the duration of a random factor N multiplied by the CCA observation time;
N defines the number of clear idle slots resulting in a total Idle Period that need to be observed before initiation of the transmission;
The value of N shall be randomly selected in the range 1 . . . q every time an Extended CCA is required and the value may be stored in a counter;
The counter is decremented every time a CCA slot is considered to be “unoccupied”;
When the counter reaches zero, the equipment may transmit.

Due to LBT requirement or other co-existence mechanisms the eNB may not always be able to transmit in SCell immediately after it has prepared a data burst for transmission in SCell. So, the LBT/CCA may cause extra latency for data transmission where the average amount of latency depends e.g. on the number of other transmitting terminals (e.g. WiFi terminals) within a cell. In order to tackle at least this problem, a dynamic carrier selection scheme is presented, by taking advantage of the fact that there is a vast amount of (contiguous) spectrum available in unlicensed 5 GHz band. In addition, various SI/WI proposals for extending the number of component carriers (CCs) beyond the current maximum number of 5 CCs are under discussion in 3GPP. It is also noted that even though aggregation capabilities of eNBs and UEs will likely improve in coming years, it is unlikely that all the potential SCells in unlicensed band are configured and activated in all network situations and scenarios.

In accordance with the exemplary embodiments of the invention there is an efficient mechanism for dynamic carrier selection is proposed by exploiting the existing CA framework of LTE.

In the example shown in FIG. 1, the SCell 14 may provide the LTE LAA carrier for the UE, where the UE is connected to the PCell 12 in the licensed spectrum for example. Features as described herein may be used to provide a new type of communication between a base station and a UE. This new communication system may comprise the base station (such as a eNB) being configured to transmit according to rules defined for Load Based Equipment (LBE), and the UE in the cell being configured to transmit according to rules defined for Frame Based Equipment (FBE). In accordance with the exemplary embodiments of the invention a dynamic carrier selection scheme for downlink in unlicensed band based on the use of auxiliary component carriers (ACCs) is presented. It may be characterized as follows:

Each SCell in unlicensed band may be associated with a number of auxiliary component carriers (ACCs) which are linked to the SCell, e.g. via system information (e.g. SIB1) or the linkage is done as part of RRC-configuration of the SCell. A set of Scells may share fully or partly the same set of ACCs while some of the Scells may not be configured with any ACC (in order to guarantee proper LAA operation for UEs with limited CA capabilities).

From the eNB point of view, any CC that is not configured as SCell (for any UE) nor is currently activated for any UE (i.e., such CC can be interpreted as turned-OFF SCell) can be configured as ACC and linked to a set of SCells in order to improve their average throughput via reduced latency. A set of active Scells can share partially or fully the same set of ACCs.

The eNB transmits a data burst, carrying a set of HARQ processes and consisting of a number of subframes (each with a length of 1 ms), to UEs in a SCell on one component carrier selected from a set of CCs where the set includes the secondary CC (SCC) and auxiliary CCs the SCell is linked to. In essence, the same set of HARQ processes associated with a certain SCell are always carried on the same set of CCs. This helps to keep the UE complexity at a manageable level since the UE needs to monitor only a limited set of CCs for its HARQ processes.

The dynamic CC selection may be based on LBT/CCA measurement results on each CC and the order of preference of CCs. The SCC has always highest priority while the ACCs may be ordered by using e.g. longer term (filtered) channel state information (CSI) provided by the UEs.

Further, it is noted that in an unlicensed band with a potentially large number of CCs, some of the CCs (i.e. SCells) may be turned-OFF in a certain network load situation. In accordance with the exemplary embodiments of the invention these turned-OFF CCs may be configured as auxiliary component carriers (ACCs) for active SCells via semi-static RRC-configuration. A set of active SCells can share partially or fully the same set of ACCs. Each SCell in unlicensed band may be associated with a number of ACCs which are linked to the CC of the SCell and can be used to deliver the HARQ processes of that SCell. ACCs and the linked SCell share the same HARQ processes. ACCs are used to transmit the data burst associated with the SCell only when LBT/CCA on the parent SCC is negative. The exemplary embodiments of the invention consider that not all the potential SCells in unlicensed band are configured and activated in all network situations and scenarios.

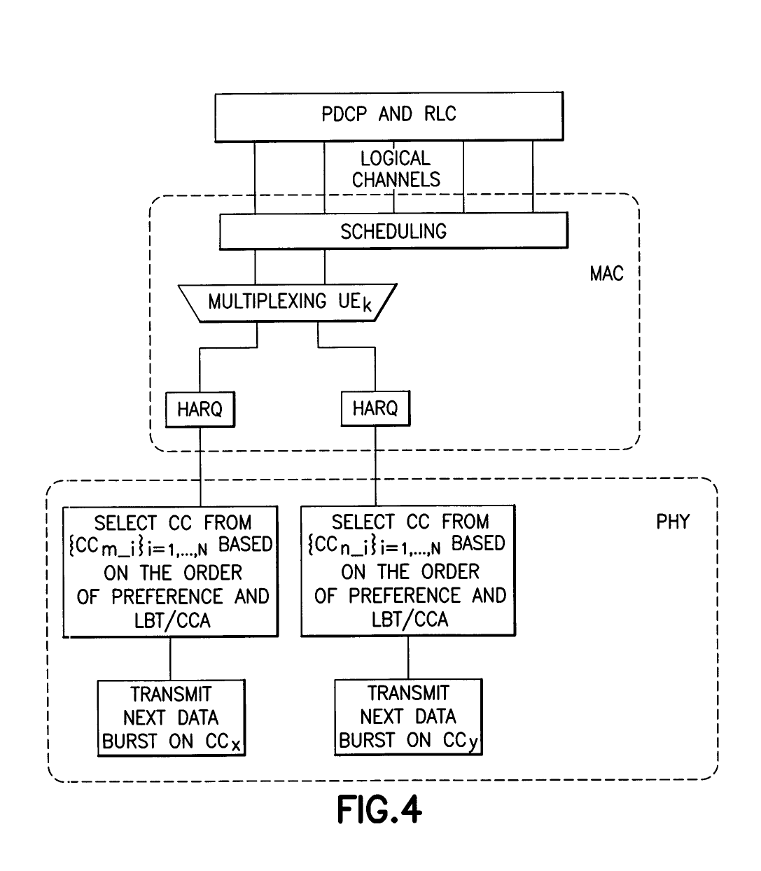

In essence, the auxiliary CCs are used to transmit the data burst associated with the SCell only when LBT/CCA on the parent SCC is negative (i.e. LBT indicates that someone else is using the channel). Thus the use of ACCs does not increase the peak data of the UE but instead it will decrease average latency of data transmission by increasing the likelihood of positive LBT/CCA for each transmission burst. The basic principle of the proposed dynamic carrier selection scheme is shown in FIG. 4. In overall, the proposed dynamic carrier selection scheme and various extensions of existing CA framework can be seen as complementary to each other.

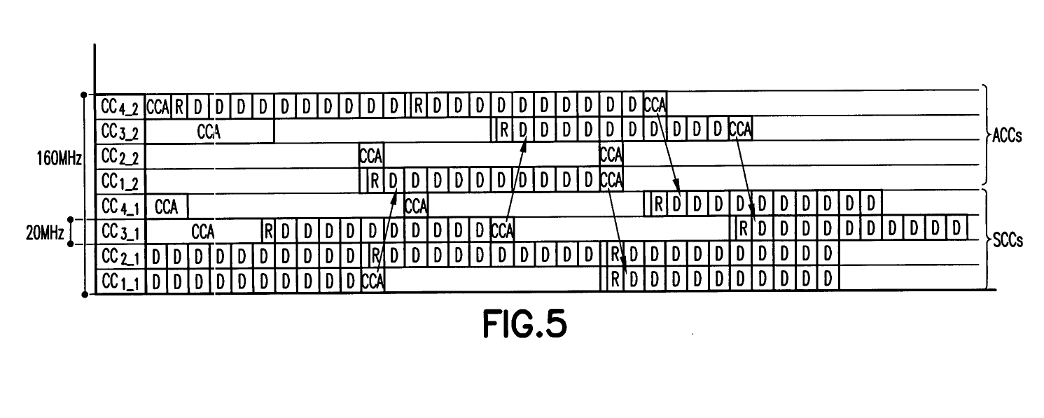

The exemplary embodiments of the invention are now described by referring to an example implementation depicted in FIG. 5. In the example, the eNB has configured and activated four SCells on unlicensed band and, in addition, each SCell is equipped with one auxiliary CC. The assumed eNB aggregation capability in this case is at least 9 CCs, i.e. PCC+4 SCCs+4 ACCs.

According to carrier aggregation (CA) system specified in Rel-10, each eNB may deploy number of component carriers (CC) in order to serve UEs within its coverage area. The number of deployed CCs may depend on the CA capability of the eNB and the amount of spectrum that the network operator is allocated with at a specific location. All CCs in Rel-10 are designed to be backward-compatible, meaning basically that each CC is fully accessible to any Rel-8 UE for example. Therefore, in this case essential Rel-8 channels and signals such as Primary and Secondary Synchronization Signals (PSS and SSS respectively) and system information (SI) specific to each CC are transmitted on the respective CC. From the higher-layer perspective, each CC appears as a separate cell with its own Cell ID.

In Rel-12 for example, a small cell ON-OFF feature was specified, enabling fast turning ON and turning OFF of a secondary cell (SCell) in CA system. In turned-OFF mode, only a specific discovery reference signal (DRS) is transmitted in a cell with a rather long periodicity, while rest of the time nothing is transmitted in a cell. The DRS enables UEs supporting this feature to make initial discovery of the cell as well as to make initial RRM measurements on a cell.

It is expected that this new cell On/Off feature will be a key ingredient of CA deployments on unlicensed band. Given that CA deployments in unlicensed band may utilize a large number of CCs (CA with 32 CCs are examined in Extended CA WID in Rel-13), it is expected that only part of CCs are configured and activated (as active SCells) for UEs in a typical network load situation while rest of CC are sleeping (i.e., turned-OFF SCells). Since the turned-OFF SCells are quiet most of the time (not transmitting anything) they can potentially be used as complementary or auxiliary CCs for active SCells, to be used whenever transmission on its associated active SCell is blocked by other systems like Wi-Fi or by other LAA system.

Therefore, the exemplary embodiments of the invention include that, in unlicensed band, a carrier such a turned off SCell carrier could be configured as an ACC that is linked via RRC signaling or via a SI to one or more active SCells. If some of active SCells is not able to carry the data burst at particular point of time due to fact that the carrier is in use of some other system (e.g. Wi-Fi) or some other LAA operator, then that data burst may be transmitted in ACC assuming that the ACC is free at that moment (should be checked by LBT procedure). In other words, a certain data burst consisting of certain HARQ processes may be transmitted in ACC in the case when the SCell activated to carry those HARQ processes is momentarily blocked by other systems. The data burst carries physical downlink control channels (PDCCHs) and physical downlink shared channels (PDSCHs) where each PDSCH comprise data elements belonging to a specific hybrid automatic repeat request process of a specific UE.

Concerning synchronization of ACCs, it is safe to assume that active SCell and the associated ACC are always synchronized (at least time synchronization applies) since they are always transmitted by the same eNB. Maybe the fine-tuning of synchronization parameters may need to be done but that can be done by using the reference signals included in the data burst (e.g. using CRS). On the other hand, an ACC may still transmit their own DRS, so that UEs entering unlicensed band can detect them as turned-off SCells (before such UE is configured and activated to any SCell). Based on DRS, all UEs operating of unlicensed band can perform RRM measurements in turned-OFF SCells (i.e. ACCs) and these measurements may be used as criterion to set ACCs associated with a certain SCell in the order of preference.

In the preferred solution, reconfiguration, addition, and removal of ACCs for each SCell is performed by RRC signaling, e.g. using SCell reconfiguration message and/or changing the content of the SI of the SCell. Thus each ACC belongs to at least one SCell and its addition and removal can be managed via SCell management procedures.

In one embodiment, a number of ACCs may be assigned to a SCell while some of the other SCells may be configured with no ACC. In that situation, UEs with high aggregation capabilities may be assigned for and scheduled in SCells that have ACCs associated with them, while UEs with low aggregation capabilities are assigned for SCells with no ACCs. Thus the UEs with high aggregation capabilities will experience lower latency on average compared to UEs with low aggregation capability.

At any point of time, the division of CCs of unlicensed band into SCCs and ACCs, performed by the eNB, may depend on number of UEs to be served in the cell range of SCells, the amount of data in the transmit buffer of the eNB, aggregation capabilities of the UEs etc. The changes in CC configurations may be done by using the reconfiguration procedures of the SCell.

A rationale behind configuring of turned-OFF SCells as ACCs and linking them to one or more active SCells is that the UE complexity can be reduced in a manageable way. With configured ACCs, the EU needs to monitor only a limited set of CCs for transmission of its HARQ processes. In the example of FIG. 5, only one ACC is configured for each active SCell and thus the UE needs to monitor only two CCs for potential transmission of its HARQ processes.

An eNB Operation in the Case That SCell is Configured with at Least One ACC:

Every time the eNB aims to transmit a data burst consisting of a number of subframes in a SCell, it will perform LBT/CCA on SCC and ACCs simultaneously and, based on the results of (e)CCA measurements and the order of the preference of the CCs, the eNB selects one CC for the transmission of that data burst. For example, if there is only one ACC linked to the SCell, the eNB checks the availability of both SCC and ACC by performing (e)CCA on both CCs and if SCC is available for transmission that is selected and if only ACC is available that is selected. If neither CCs are currently available the eNB continues the polling of both CCs and selects the one which becomes first available.

When (e)CCA indicates that the channel is available the eNB may transmit a reservation signal on CC until the start of the next subframe. The reservation signal may or may not include useful (PDCCH) data symbols. It may alternatively/additionally include cell-specific ID signature signal, e.g. cell-specific CRS. Note that the reservation signals are marked with the letter ‘R’ in FIG. 5.

The UE Operation in the Case That SCell is Configured With at Least One ACC:

When a UE has aggregation capability which enables simultaneous detection on all configured SCCs and their respective ACCs, the UE is assumed to try to decode PDCCH on those CCs continuously until a successful decoding of at least the common control signals like physical control format indicator channel (PCFICH) or equivalent or until a successful decoding of PDSCH assignment message targeted for the UE. The successful decoding of at least some part of PDCCH indicates to the UE whether SCC or some of the ACCs is used for transmission of the next data burst. The length of the transmission burst in terms of the number of subframes (1 ms) is assumed to be semi-statically configured or provided by the system information. During transmission of the data burst the PDCCH need to be decoded only on CC that is used to carry the data burst. In accordance with the exemplary embodiments the LTE does not need to monitor or decode PDCCH on the ACCs, at least not regularly since the ACC may then be scheduled via the linked active SCell. With the introduction of configurable ACCs a search space of PDCCH messages can be restricted and thus the UE complexity is reduced.

According to another embodiment, the reservation signal is assumed to have a length of at least one data symbol and it is assumed to include some type of cell specific common reference signal which the UE can detect and determine which CC is used for the transmission of the next subframe. Or a hybrid solution may be assumed where both the reservation signal and PDCCH may be used by the UE to detect which CC will be used to carry the next data burst.

According to yet another embodiment, a UE with a limited aggregation capability may also be assigned for the SCell that is furnished with ACCs but there maybe a scheduling restriction involved. For that UE there may be a cross-carrier scheduling assignment or some other indication signal in PCell which will indicate the selected CC for the next data burst. If needed, the UE will then switch from one carrier to another according to the guidance given in the PCell. Due to the time required for the preparation of the cross-carrier scheduling assignment (or some other indication signal) by the eNB and the time required to switch from one carrier to another by the UE, the first few (e.g. 2-5) subframes from the beginning of the data burst cannot be used for scheduling of that UE. Alternatively the UEs with limited aggregation capability can be assigned for the SCells that don't include any ACCs.

Then, at some point of time, there may be a UE category defined which requires a capability to detect a large (contiguous) spectrum e.g. on unlicensed band (e.g. 32 CCs) but the maximum number of supported HARQ processes is limited, mainly due to cost reasons (a huge number of HARQ processes requires lots of memory and processing power at the baseband). Such UEs can be scheduled without restrictions even when ACCs are involved.

One disadvantage of the proposed solution from the UE point of view is that link adaption, which is typically based on CSI measurements on SCC, may not work in an optimal manner for data transmission on ACC. One solution is that CRS is transmitted by eNB also on ACC with a configurable periodicity and UE measures channel quality on both SCC and ACC and takes both measurements into account when preparing channel quality indicator (CQI) to the eNB. Or alternative solution is that the UE transmits also CQI offset between SCC and ACC along with regular CQI and the eNB can take that offset into account when making final scheduling decisions for the UE. In any case, the sub optimality of link adaptation is a general problem pertaining to all dynamic carrier selection schemes.

This solution has at least the following advantages:

A vast available spectrum on unlicensed band can be effectively used to reduce transmission latency caused by co-existence requirements.

Also UEs with a limited aggregation capability maybe able to benefit from the vast available spectrum on unlicensed band.

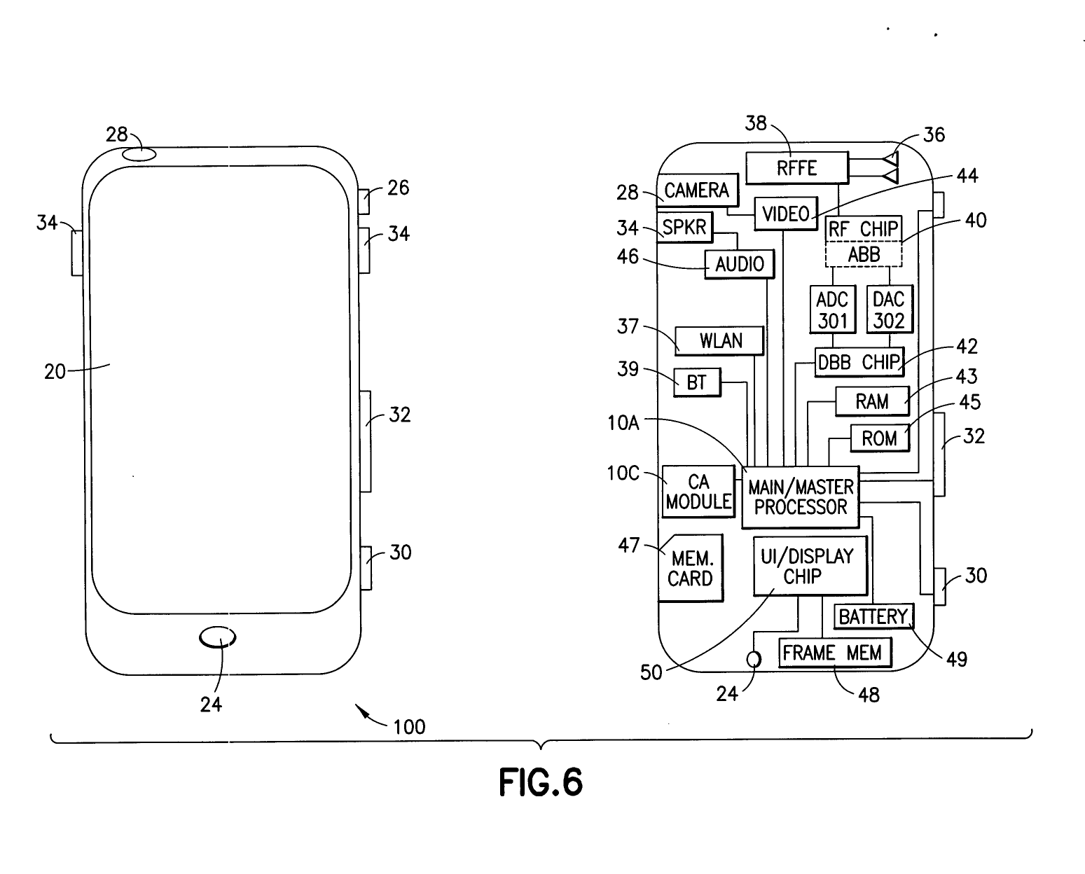

FIG. 6 shows a schematic diagram in plain view (left) and sectional view (right) of a mobile handset capable of performing operations according to an exemplary embodiment of the invention. The mobile handset may be a UE 100 as shown in FIG. 2. The UE 100 in both plan view (left) and sectional view (right) which maybe configured to perform the operations in accordance with the exemplary embodiments. As shown in FIG. 6, the UE 100 includes a graphical display interface (e.g., touchscreen) 20 and a user interface that comprises a microphone 24 and speaker(s) 34 and touch-screen technology at the graphical display interface 20 and/or voice-recognition technology for audio signals received at the microphone 24. A power actuator 26 controls the UE 100 being turned on and/or off by the user. The UE 100 may include a camera(s) module 28, which is shown as forward facing (e.g., for video calls) but may alternatively or additionally be rearward facing (e.g., for capturing images and video for local storage). The camera(s) 28 may be controlled by a shutter actuator 30 and optionally by a zoom actuator 32, which may alternatively function as a volume adjustment for the speaker(s) 34 when the camera 28 is not in an active mode. Signals to and from the camera(s) 28 pass through an image/video processor (video) 44, which encodes and decodes the image data (e.g., image frames). A separate audio processor 46 may also be present to control signals to and from the speakers (spkr) 34 and the microphone 24. The graphical display interface 20 is refreshed from a frame memory (frame mem) 48 as controlled by a user GPU 50, which may process signals to and from the display interface 20. These actuators may also be implemented using touch-screen technology.

Also within the sectional view of FIG. 6 are seen multiple transmit/receive antennas 36 that are typically used for wireless communication (e.g., cellular communication). The antennas 36 may be multi-band for use with other radios in the UE. The operable ground plane for the antennas 36 may span the entire space enclosed by the UE housing, though in some embodiments the ground plane may be limited to a smaller area, such as disposed on a printed wiring board on which a RF front-end (RFFE) 38 is formed. The RFFE 38 controls power amplification on the channels being transmitted on and/or across the antennas that transmit simultaneously, where spatial diversity is used. The RFFE 38 outputs to the radio frequency (RF) chip 40, which amplifies, demodulates and down converts the signal for analog baseband (ABB) processing. The analog to digital converter (ADC) 301 converted analog signal to bit-stream, which the digital baseband (DBB) chip 42 detects and finally decoded. Similar processing occurs in reverse for signals generated in the UE 100 and transmitted from the UE.

In addition, the UE 100 may perform carrier aggregation communication, including activating and deactivating carriers for carrier aggregation operations as described herein. The activating and deactivating of the carriers for carrier aggregation may be applied to communications involving received and/or transmitted data. Functions associated carrier aggregation including, but not limited to, the performing, the activating, and/or the deactivating of carriers for carrier aggregation operations may be enabled by circuitry such as in the CA module 10C of FIG. 6.

The DBB and/or RFIC may also include any of a processor and a memory including computer program code, which controlling transceivers parameters to optimize performance of it. Program code could be storage to memory and it may include algorithms and/or lookup tables (LUT). In addition, it is noted that the placement of any of these components are not limiting and any of the components shown in FIG. 6 maybe placed differently and still operate in accordance with the exemplary embodiments. As an example, the ADC and DAC could be on the RFIC side or in the BB side or they even could be separate from both. It is noted that any of the configuration shown in FIG. 6 is not limiting to operations performed in accordance with the exemplary embodiments of the invention.

Certain exemplary embodiments of the UE 100 may also include one or more secondary radios such as a wireless local area network radio (WLAN) 37 and/or a Bluetooth radio (BT) 39, which may incorporate one or more on-chip antennas or be coupled to one or more off-chip antennas. Throughout the UE 100 are various memories 125, such as a random access memory (RAM) 43, a read only memory (ROM) 45, and, in some exemplary embodiments, a removable memory such as the illustrated memory card 47. In some exemplary embodiments, various programs (such as computer program code 315) are stored on the memory card 47. The components within the UE 100 may be powered by a portable power supply such as a battery 49.

It is noted that the communications and/or operations as described in FIGS. 1, 2, 3, 4, 5, 6, and/or 7 are non-limiting to the exemplary embodiments of the invention. The devices and the related operations are merely illustrative of devices and operations for use in practicing the exemplary embodiments of this invention. Further, any of these operations can be performed using any suitable device including a mobile device such as a user equipment as shown in FIG. 6. Further, the operations as described below may be performed in a different order and/or by different devices than what is described. The exemplary embodiments of the invention may be used in any device which includes a capability to perform carrier aggregation. Such device can include, but are not limited to, smartphones, tablets, and PDAs.

Further, the exemplary embodiments of the invention may be practiced in any device such as a device with an LTE interface.

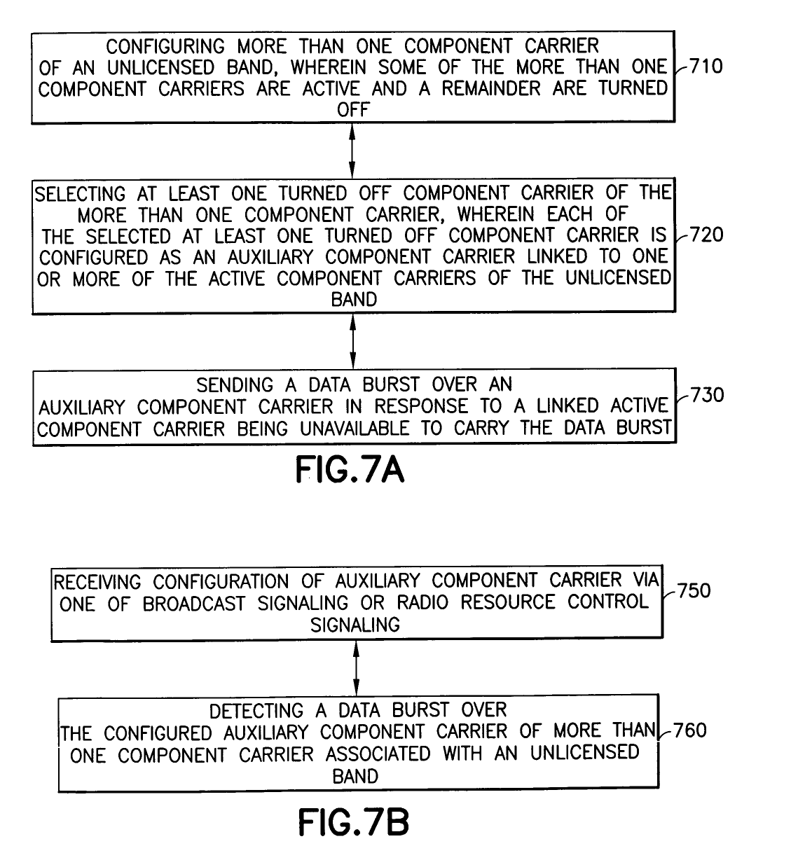

FIG. 7A illustrates operations which may be performed by a network device such as, but not limited to, a carrier select device (e.g., the C_select device 220 as in FIG. 2). As shown in step 710 of FIG. 7A, there is configuring more than one component carrier of an unlicensed band, wherein some of the more than one component carriers are active and a remainder are turned off. As shown in step 720 of FIG. 7A, there is selecting at least one turned off component carrier of the more than one component carrier, wherein each of the selected at least one turned off component carrier is configured as an auxiliary component carrier linked to one or more of the active component carriers of the unlicensed band. Then as shown in step 730 of FIG. 7A there is sending a data burst over an auxiliary component carrier in response to a linked active component carrier being unavailable to carry the data burst.

In accordance with the exemplary embodiments as described in the paragraph above, the data burst carries physical downlink control channels and physical downlink shared channels, and wherein each physical downlink shared channel comprises data elements belonging to a specific hybrid automatic repeat request process of a specific user equipment.

In accordance with the exemplary embodiments as described in the paragraphs above, the auxiliary component carrier is used to carry the data burst which was originally scheduled for transmission on a component carrier belonging to an active SCell when the active SCell is unavailable for transmission.

In accordance with the exemplary embodiments as described in the paragraphs above, a set of hybrid automatic repeat request processes which are associated with the active SCell is sent on the auxiliary component carrier when the active SCell is unavailable for transmission so that the active SCell and auxiliary component carrier share the set of hybrid automatic repeat request processes.

In accordance with the exemplary embodiments as described in the paragraphs above, there is at least one of reconfiguring, adding, and removing auxiliary component carriers associated with one or more cells of the unlicensed band using the at least one of radio resource control and system information signaling, wherein the at least one of reconfiguring, adding, and removing is based on a number of network devices to be served in a cell range of the one or more cells of the unlicensed band.

In accordance with the exemplary embodiments as described in the paragraphs above, the auxiliary component carrier is selected to carry the data burst based on at least one of a clear channel assessment and a listen before talk assessment of a linked secondary component carrier in the unlicensed band.

In accordance with the exemplary embodiments as described in the paragraphs above, the selecting of an auxiliary component carrier to carry the data burst, if multiple auxiliary component carriers are linked to one active SCell, is using an order of preference of the more than one component carrier based on the at least one of the clear channel assessment and the listen before talk assessment and channel state information measurements of each auxiliary component carrier.

In accordance with the exemplary embodiments as described in the paragraphs above, the operations can be performed by a base station.

In the exemplary aspect of the invention according to the paragraph above, wherein the means for configuring, selecting, and sending comprises a non-transitory computer readable medium [MEM 204, 224, and/or 254] encoded with a computer program [PROG 208, 228, and/or 258]; and/or [Data 206, 226, and 256] executable by at least one processor [DP 202, 222, and/or 252].

FIG. 7B illustrates operations which may be performed by a network device such as, but not limited to, a mobile device (e.g., the LTE 100 as in FIG. 2). As shown in step 750 of FIG. 7B there is, receiving a configuration of and auxiliary component carrier via one of broadcast signaling or radio resource control signaling. As shown in step 760 of FIG. 7B there is detecting a data burst over the configured auxiliary component carrier of more than one component carrier associated with an unlicensed band.

In accordance with the exemplary embodiments as described in the paragraphs above, the data burst carries physical downlink control channels and physical downlink shared channels, and wherein each physical downlink shared channel comprises data elements belonging to a specific hybrid automatic repeat request process of a specific user equipment.

In accordance with the exemplary embodiments as described in the paragraphs above, the auxiliary component carrier using a turned off component carrier that is linked to one or more active component carriers of the unlicensed band.

In accordance with the exemplary embodiments as described in the paragraphs above, the operations can be performed by a mobile device.

In the exemplary aspect of the invention according to the paragraph above, wherein the means for receiving and detecting comprises a non-transitory computer readable medium [MEM 204, 224, and/or 254] encoded with a computer program [FROG 208, 228, and/or 258]; and/or [Data 206, 226, and 256] executable by at least one processor [DP 202, 222, and/or 252].

The apparatus may be, include or be associated with at least one software application, module, unit or entity configured as arithmetic operation, or as a computer program or portions thereof (including an added or updated software routine), executed by at least one operation processor, unit or module. Computer programs, also called program products or simply programs, including software routines, applets and/or macros, may be stored in any apparatus-readable data storage medium. A computer program product may comprise one or more computer-executable components which, when the program is run, are configured to carry out embodiments described above by means of FIGS. 7A and/or 7B. Additionally, software routines may be downloaded into the apparatus.

The apparatus, such as a node or user device, or a corresponding component, may be configured as a computer or a microprocessor, such as single-chip computer element, or as a chipset, including or being coupled to a memory for providing storage capacity used for software or arithmetic operation(s) and at least one operation processor for executing the software or arithmetic operation(s).

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof_{?}mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. An apparatus comprising:
at least one processor; and
at least one memory including computer program code, where the at least one memory and the computer program code are configured, with the at least one processor, to cause the apparatus to at least:
configure more than one component carrier of an unlicensed band, wherein some of the more than one component carriers are active and a remainder are turned off;
select at least one turned off component carrier of the more than one component carrier, wherein each of the selected at least one turned off component carrier is configured as an auxiliary component carrier linked to one or more of the active component carriers of the unlicensed band; and
send a data burst over an auxiliary component carrier in response to a linked active component carrier being unavailable to carry the data burst.

2. The apparatus according to claim 1, wherein the data burst carries physical downlink control channels and physical downlink shared channels, and wherein each physical downlink shared channel comprises data elements belonging to a specific hybrid automatic repeat request process of a specific user equipment.

3. The apparatus according to claim 1, wherein the auxiliary component carrier is used to carry the data burst which was originally scheduled for transmission on a component carrier belonging to an active SCell when the active SCell is unavailable for transmission.

4. The apparatus according to claim 3, wherein a set of hybrid automatic repeat request processes which are associated with the active SCell is sent on the auxiliary component carrier when the active SCell is unavailable for transmission so that the active SCell and auxiliary component carrier share the set of hybrid automatic repeat request processes.

5. The apparatus according to claim 1, wherein the at least one memory including the computer program code is configured with the at least one processor to cause the apparatus to at least one of reconfigure, add, and remove auxiliary component carriers associated with one or more cells of the unlicensed band using at least one of radio resource control and system information signaling, wherein the at least one of reconfiguring, adding, and removing is based on a number of network devices to be served in a cell range of the one or more cells of the unlicensed band.

6. The apparatus according to claim 1, wherein the auxiliary component carrier is selected to carry the data burst based on at least one of a clear channel assessment and a listen before talk assessment of a linked secondary component carrier in the unlicensed band.

7. The apparatus according to claim 6, wherein the selecting of an auxiliary component carrier to carry the data burst, if multiple auxiliary component carriers are linked to one active SCell, is using an order of preference of the more than one component carriers based on the at least one of the clear channel assessment, the listen before talk assessment and channel state information measurements of each auxiliary component carrier.

8. A method, comprising:
configuring more than one component carrier of an unlicensed band, wherein some of the more than one component carriers are active and a remainder are turned off;
selecting at least one turned off component carrier of the more than one component carrier, wherein each of the selected at least one turned off component carrier is configured as an auxiliary component carrier linked to one or more of the active component carriers of the unlicensed band; and
sending a data burst over an auxiliary component carrier in response to a linked active component carrier being unavailable to carry the data burst.

9. The method according to claim 8, wherein the data burst carries physical downlink control channels and physical downlink shared channels, and wherein each physical downlink shared channel comprises data elements belonging to a specific hybrid automatic repeat request process of a specific user equipment.

10. The method according to claim 8, wherein the auxiliary component carrier is used to carry the data burst which was originally scheduled for transmission on a component carrier belonging to an active SCell when the active SCell is unavailable for transmission.

11. The method according to claim 8, comprising at least one of reconfiguring, adding, and removing auxiliary component carriers associated with one or more cells of the unlicensed band using the at least one of radio resource control and system information signaling, wherein the at least one of reconfiguring, adding, and removing is based on a number of network devices to be served in a cell range of the one or more cells of the unlicensed band.

12. The method according to claim 8, wherein the auxiliary component carrier is selected to carry the data burst based on at least one of a clear channel assessment and a listen before talk assessment of a linked secondary component carrier in the unlicensed band.

13. The method according to claim 12, wherein the selecting of an auxiliary component carrier to carry the data burst, if multiple auxiliary component carriers are linked to one active SCell, is using an order of preference of the more than one component carrier based on the at least one of the clear channel assessment and the listen before talk assessment and channel state information measurements of each auxiliary component carrier.

14. An apparatus comprising:
at least one processor; and
at least one memory including computer program code, where the at least one memory and the computer program code are configured, with the at least one processor, to cause the apparatus to at least:
receive a configuration of an auxiliary component carrier via one of broadcast signaling or radio resource control signaling;
detect a data burst over the configured auxiliary component carrier of more than one component carrier associated with an unlicensed band.

15. The apparatus according to claim 14, wherein the data burst carries physical downlink control channels and physical downlink shared channels, and wherein each physical downlink shared channel comprises data elements belonging to a specific hybrid automatic repeat request process of a specific user equipment.

16. The apparatus according to claim 14, wherein the auxiliary component carrier using a turned off component carrier that is linked to one or more active component carriers of the unlicensed band.

17. The apparatus according to claim 14 embodying a mobile device.

18. A method, comprising:
receiving, by a user equipment, a configuration of an auxiliary component carrier via one of broadcast signaling or radio resource control signaling; and
detecting a data burst over the auxiliary component carrier of more than one component carrier associated with an unlicensed band.

19. The method according to claim 18, wherein the data burst carries physical downlink control channels and physical downlink shared channels, and wherein each physical downlink shared channel comprises data elements belonging to a specific hybrid automatic repeat request process of the user equipment.

20. The method according to claim 18, wherein the auxiliary component carrier is using a turned off component carrier that is linked to one or more active component carriers of the unlicensed band.
